(19) United States
(12) Patent Application Publication
(10) Pub. No.: US 2006/0244314 A1
(43) Pub. Date: Nov. 2, 2006

(54) Hybrid power supply assembly utilizing an ultra-capacitor array

(76) Inventor: Fred Graham, Nashville, TN (US)

Correspondence Address: MICHAEL E. MCKEE;Attorney at Law, 804 Swaps Lane, Knoxville, TN, 37923, US

(21) Appl. No.: 11/116,013

(22) Filed: Apr. 27, 2005

(51) Int. Cl. H02J 3/32

(52) U.S. Cl. 307/46

(57) ABSTRACT

A power supply assembly for an electrical component whose largest load requirements during operation are intermittent includes a principal power supply for supplying the operating power for the electrical component for a major fraction of the period of operation of the electrical component yet is incapable of supplying the largest load requirements of the electrical component during the remaining and intermittent periods of operation of the electrical component. However, the power supply assembly further includes a plurality of ultra-capacitors for discharging electrical power to the electrical component during the intervals of time when the load requirements of the electrical component exceed the output capabilities of the principal power supply.

### BACKGROUND OF THE INVENTION

This invention relates generally to means and methods for supplying electrical power to electrical devices and relates, more particularly, to means for supplying electrical power to electrical devices whose largest power demands are intermittent.

There exists a large class of electrical devices whose components experience their largest (e.g. peak) power demands on an intermittent, rather than a continuous, basis. Consequently, the withdrawal of the largest (e.g. peak) power necessary for operation of those components occurs intermittently, rather than continuously. Furthermore, the time intervals during which the largest electrical demand is required by these devices during operation is commonly short in duration so that the amount of time which the components spend while operating during the largest power demand periods comprises only a small fraction of the total time spent in operation. Examples of electrical devices of this class include those associated with communication equipment, such as radio transceivers and audio amplifiers, whose components commonly require peak, or full, load power only during time intervals when sound-carrying signals are being conducted or operated upon by such components.

In order to ensure that sufficient electrical power is available to meet the peak power demands during operation of such electrical devices, power supply sources, such as a battery power supply, designed for use with these electrical devices are, in many instances, relatively large and weighty. Consequently, within a self-contained electrical unit which includes both the electrical device and a power supply source, the power supply source comprises a relatively high percentage of the total weight and volume of the unit. It would be desirable to provide an alternative power supply source for such an electrical device so that the total weight and volume of a self-contained unit which includes both the electrical device and the power supply source can be reduced.

Accordingly, it is an object of the present invention to provide a new and improved power supply assembly from which the operating power for an electrical device of the aforedescribed class can be withdrawn.

Another object of the present invention is to provide such a power supply assembly which enables the total weight or volume of a unit which includes both the electrical device and the power supply to be reduced.

Still another object of the present invention is to provide such a power supply which is uncomplicated in structure, yet effective in operation.

### SUMMARY OF THE INVENTION

This invention resides in a power supply assembly for an electrical component whose largest load requirements during operation are intermittent.

The power supply assembly includes principal power supply means for supplying the operating power for the electrical component for a major fraction of the period of operation of the electrical component yet is incapable of supplying the largest load requirements of the electrical component during the intermittent periods of operation of the electrical component. Furthermore, the assembly includes a plurality of ultra-capacitors connected in-line with one another and in parallel with the principal power supply for discharging, or supplying, enhanced electrical power to the electrical component during the intervals of time when the load requirements of the electrical component exceed the output capabilities of the principal power supply.

### BRIEF DESCRIPTION OF THE DRAWINGS

FIG. 1 is a wiring block diagram of an exemplary embodiment of an electrically-powered unit which utilizes an electrical power supply assembly incorporating features of the present invention.

FIG. 2 is a graph plotting the discharge of a 5 Farad capacitor being discharged by a 200 watt load from an initial voltage of 13.5 VDC for a period of 0.5 seconds.

FIG. 3 is a wiring diagram of an electrical device with which an alternative power supply assembly is employed.

### DETAILED DESCRIPTION OF THE ILLUSTRATIVE EMBODIMENTS

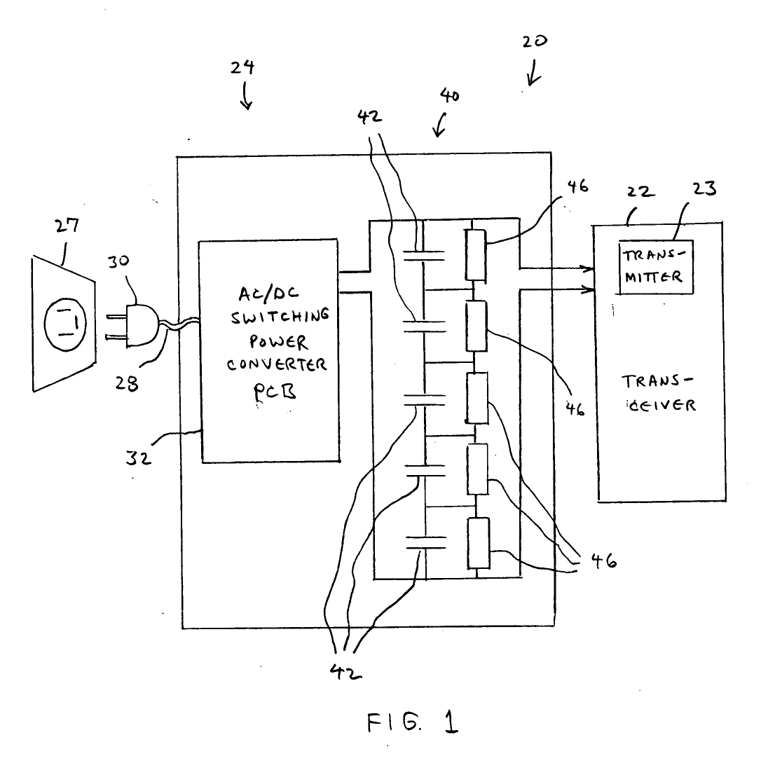

Turning now to the drawings in greater detail and considering first FIG. 1, there is illustrated a wiring diagram of an exemplary embodiment, generally indicated 20, of an electrical unit within which a power supply assembly, generally indicated 24 and embodying features of the present invention, can be used. The depicted unit 20 can include a radio transceiver 22 which, in turn, includes a load-consuming electrical device in the form of a 100-watt class solid state radio transmitter 23. As will be apparent herein, the power supply assembly 24 of the unit 20 is adapted to provide electrical power to the transceiver 22 for operation thereof.

The depicted transceiver 22 is of a class of radios which are relatively small and therefore well-suited for mobile applications. In addition, these radios typically operate from a twelve volt DC source and are capable of delivering 100 watts of radio frequency (RF) power to an antenna or dummy load in a number of different emission modes; i.e. Voice Single Side Band (SSB) suppressed carrier, Keyed Carrier (Morse code), Amplitude Modulation (AM), Frequency Modulation (FM), and Radio Teletype (RTTY). Each of the last three of these five-mentioned modes requires that the radio deliver RF power continuously while in the transmit mode. However, in Voice SSB and Keyed Carrier modes, the radio delivers RF power only when the operator's voice or the Morse key is active. When the voice is not present, such as during pauses between words and syllables, or when the Morse key is not being depressed, the radio requires only small amounts of power (i.e. housekeeping power) for the receiver, and general bias circuitry.

In prior art applications, transceivers, such as the transceiver 22, are capable of being operated from a twelve-volt automobile battery. Alternatively, they can be operated from a power line-connected, regulated DC power supply which are usually designed to provide the full amount of power required by the radio for continuous operation in every emission modes. In other words, such a regulated DC power supply is usually provided with the capacity to continuously provide the transceiver with an amount of electrical power equal to the peak power requirements of the transceiver. Consequently and heretofore, the power supply for such a radio transceiver has been frequently two or three times larger than the radio within which the transceiver is utilized and can weigh up to twenty pounds.

Electrical components for Voice and Morse code units have power duty cycle factors of twenty-five percent to thirty-five percent. Therefore, the average power required to operate a SSB or Morse code transmitter is only twenty-five percent to thirty-five percent of the peak power requirement. A one-hundred-watt transceiver with an operating efficiency of fifty percent would require about two-hundred watts of peak power during voice articulation or during the short dashes and dots associated with Keyed Carrier Morse code characters. Given the twenty-five percent average power content mentioned above, the power supply would need to provide two-hundred peak watts, but would need to supply only an average of fifty watts continuously.

With the foregoing in mind, the invention described herein addresses the need for a small, lightweight power supply assembly which is capable of delivering the needed peak and average power requirements to a radio during SSB and Keyed Carrier modes of operation. Furthermore, this power supply assembly would then be more conveniently transported and stored by owners and operators of solid state transceivers. It could be incorporated subsequently into the body of the radio without egregiously increasing the size and weight of the radio.

With reference again to FIG. 1, the power supply assembly 24 of the unit 20 is a voltage-regulated, current limited, switching converter which is configured to be plugged into an electrical power outlet 27 for withdrawing AC power therefrom and converting the withdrawn AC power to DC power for use by the transceiver 22. To this end, the assembly 24 includes an electrical cord 28 having a plug 30 at one end thereof and a printed circuit board 32 upon which appropriate electrical components are supported for converting AC power withdrawn from the electrical outlet 27 to DC power for use by the transceiver 22. The electrical components suitable for converting the withdrawn AC power to DC power are well-known in the art so that a detailed description of them is not believed to be necessary. Suffice it to say that within the depicted assembly 24, the printed circuit board 32 includes components for appropriately converting electrical power (e.g. rated 110 volts AC) withdrawn from the outlet 27 to about 13.5 volts DC with a 5 amp current limit. It therefore follows that with the electrical power being delivered to the transceiver 22 through the assembly 24, the power supply delivered to the transceiver 22 can be categorized as a line-connected, regulated DC power supply. However and as is apparent from the 13.5 volt output and the 5 amp current limit, the power supply assembly 24 is not designed to provide the full amount of power (e.g. two-hundred watts) required by the transceiver 22 for continuous operation in every emission mode.

It is a feature of the present invention that the power supply assembly 24 also includes an array 40 of ultra-capacitors 42 which are connected in series with one another and wherein the array 40 is connected in parallel with the transceiver 22 and the printed circuit board 32. Within the depicted unit 20, the array 40 includes a plurality of (i.e. five) ultra-capacitors 42 which are each rated at 25 Farads. Furthermore, a fifteen ohm voltage equalizing resistor 46 is wired across each ultra-capacitor 42 so that the voltage measured across each ultra-capacitor 42 is 2.7 volts. With 2.7 volts being measured across each ultra-capacitor 42, the sum of the voltage across the five ultra-capacitors 42 connected in series equals 13.5 volts, and thus the measured output of the power supply assembly 24.

Ultra-capacitors are similar to common electrolytic capacitors in that they each have small internal resistance which, in turn, introduces only slight inefficiencies to their operation. At the same time, however, ultra-capacitors are capable of providing a very large capacitance, that is to say, a capacitance which is orders of magnitude greater than can be provided by electrolytic capacitors of similar size. Further still and although the period over which an ultra-capacitor can discharge its stored power is relatively short, ultra-capacitors can be considered as nearly perfect energy storage and delivery devices in that they exhibit no electrochemical inefficiencies during charging and discharging. In other words, energy put into an ultra-capacitor equals energy capable of being withdrawn from an ultra-capacitor.

With reference again to FIG. 1 and in accordance with the foregoing discussion regarding the power requirements of radio components adapted to operate in SSB or Keyed Carrier modes, the transceiver 22 of the FIG. 1 embodiment 20 requires peak power about twenty-five percent of the time. Accordingly, the ultra-capacitor array 40 would need to, and does, provide the necessary power to the transceiver 22 during that period of time (i.e. the twenty-five percent time period). During the remaining seventy-five percent time period, the power requirements of the transceiver 22 can be met by the output of the assembly 24. During this same period of time (i.e. when power is not being withdrawn from the ultra-capacitor array 40), the ultra-capacitors 42 of the array 40 are recharged, as necessary, by the output of the power converter PCB 32.

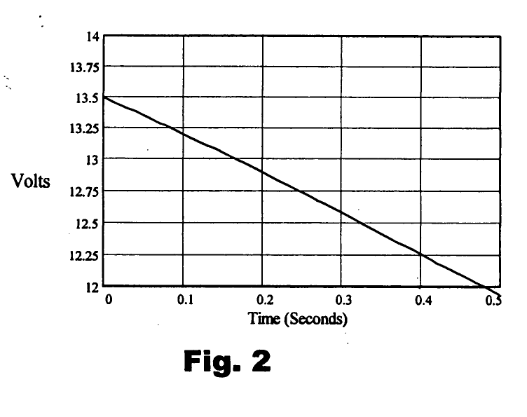

With reference to FIG. 2, there is illustrated a graph (plotting volts versus time in seconds) which displays the discharge characteristics of the a five Farad capacitor being discharged by a 200-watt load (about 15 Amps) from an initial voltage of 13.5 VDC for 0.5 seconds. As depicted in the FIG. 2 graph, the voltage discharge does not drop below about 12 volts until about 0.50 seconds passes from discharge initiation, and this period of time is well beyond the duration of a typical impulse during which peak power is required by the transceiver 22 for Voice SSB or Keyed Carrier operation. Moreover, immediately upon cessation of the peak power requirements of the transceiver 22 during Voice SSB and Keyed Carrier operation, the ultra-capacitor array 40 and in particular, the capacitors 42 of the array 40, begin to be recharged. Consequently and in practice, the capacitor array 40, in this FIG. 1 embodiment, seldom drops below 13.0 VDC.

To summarize, the marrying of a line-operated switching supply having a capacity to meet only about twenty-five percent of the peak power capability of a transceiver with an appropriately-sized ultra-capacitor array, i.e. rated between about 5 to 25 Farads, results in a considerable weight and volume reduction of the power supply system. Furthermore, this scheme allows the power supply assembly to function in various radio transmission modes, i.e. Voice SSB and Keyed Carrier modes, as though the power supply assembly was designed for four times the power. As mentioned earlier, the power supply assembly 24 of the depicted unit 20 weighs about one pound and is about ⅙th the volume of a conventional power supply.

The principles described herein can also be used in conjunction with power supplies incorporated into solid state audio amplifiers. Applying the knowledge that peak power is utilized by audio amplifiers for voice and music during only a fraction of the time that the audio amplifiers are energized, the utilization of a suitable ultra-capacitor array with such an audio amplifier would result in power supply for the amplifier which is substantially reduced in cost, weight and volume.

It will be understood that numerous modifications and substitutions can be had to the aforedescribed embodiment without departing from the spirit of the invention. For example, although the aforedescribed ultra-capacitor array 40 of the embodiment 20 has been shown and described for use with a transceiver 22, such an ultra-capacitor array 40 can be scaled to any peak to average power ratio requirement for any electronic device. A ultra-capacitor hybrid power supply could be fully characterized by a simple equation incorporating variables such as required average power, required peak power, peak power duration, and output voltage regulation limits. Another equation which defines the power enhancement derived from an ultra-capacitor hybrid power supply may appear in the following form:
Enhanced Amps=Rated Amps/Duty Cycle
thus
Short Duration Output Power=Enhanced Amps×Volts
Again, the advantage of such an ultra-capacitor-including system would be the reduction of cost, weight, and volume of the power supply.

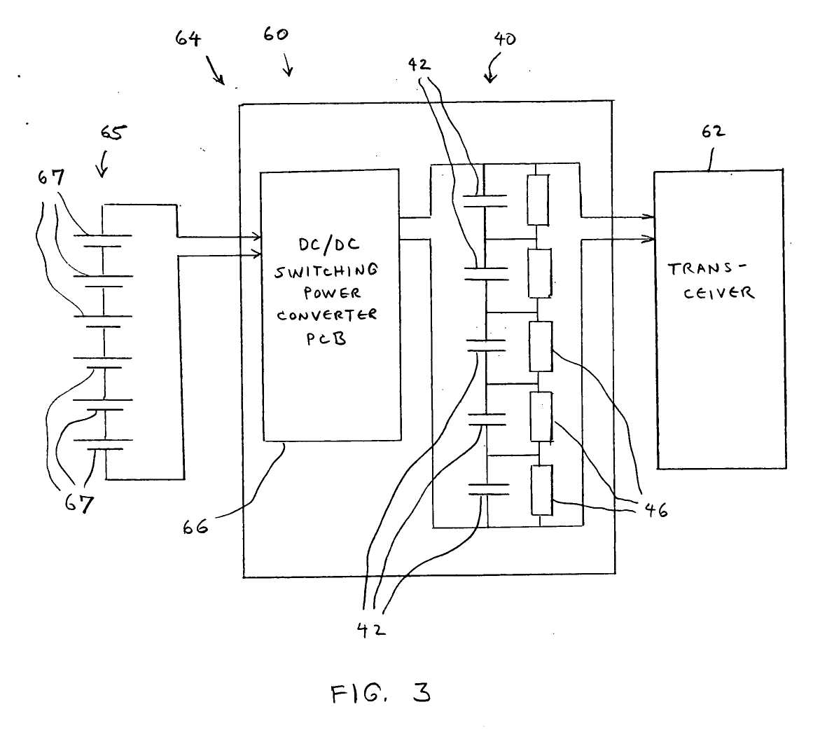

Furthermore and although the aforedescribed embodiment 20 has been shown and described as including a principal power source which withdraws AC electrical power from a wall outlet for conversion to DC power, an alternative embodiment of the invention can include a battery power source. For example, there is illustrated in FIG. 3 an embodiment, generally indicated 60, of a power supply assembly 64 and a load-consuming transceiver 62 of a one-hundred watt class and a principal power source 65 comprised of a bank of storage batteries 67 whose combined DC output measures about 13.8 volts. Appropriately wired to the power source 65 is a printed circuit board 66 upon which electrical components are supported converting the DC power which is withdrawn from the power source 65 to a suitable level of DC voltage for use by the transceiver 62. As is the case with the embodiment 20 of FIG. 1, the FIG. 3 embodiment 60 includes an array 40 of five ultra-capacitors 42 which are connected in series with one another and wherein the array 40 is connected in parallel with the transceiver 42 and the printed circuit board 66.

Further still, a fifteen ohm voltage equalizing resistor 46 is wired across each ultra-capacitor 42. In practice, the battery power supply 65 is incapable of meeting the intermittent peak power demands of the transceiver 62 (operating, for example, in an SSB or Keyed Carrier mode), but the ultra-capacitor array 40 possesses that capability. Consequently, when the transceiver 62 requires the largest power demands, the necessary power needed to meet those demands is drawn from the ultra-capacitor array 40. Meanwhile and between those intermittent large power demands, the transceiver 62 withdraws its operating power from the battery power source 65 and the ultra-capacitor array 40 is permitted to be recharged, as necessary, from the battery power source 65.

Accordingly, the aforedescribed embodiment 20 is intended for the purpose of illustration and not as limitation.

1. A power supply assembly for an electrical component whose largest load requirements during operation are intermittent, the power supply comprising:
principal power supply means for supplying the operating power for the electrical component for a major fraction of the period of operation of the electrical component yet is incapable of supplying the largest load requirements of the electrical component during the remaining and intermittent periods of operation of the electrical component; and
a plurality of ultra-capacitors connected in-line with one another and in parallel with the principal power supply for discharging electrical power to the electrical component during the intervals of time when the load requirements of the electrical component exceed the output capabilities of the principal power supply.

2. The power supply assembly as defined in claim 1 wherein the plurality of ultra-capacitors is connected to the principal power supply means so that during the intervals of time when operating power is being supplied to the electrical component from the principal power supply means, the ultra-capacitors are capable of being recharged by the principal power supply.

3. The power supply assembly as defined in claim 1 wherein the plurality of ultra-capacitors is adapted to provide sufficient power to the load-consuming component over intermittent periods of time totaling no more than between about twenty-five to thirty-five percent of the operating time of the load-consuming component, and the principal power supply means is adapted to be able to provide the power demands of the load-consuming component for the remaining period of operating time of the load-consuming component.

4. The power supply assembly as defined in claim 3 wherein the load-consuming component with which the assembly is intended to be used is a one-hundred watt class solid state transceiver, and the plurality of ultra-capacitors has a total output capacity of about 13.5 volts DC.

5. An electrical unit comprising:
a load-consuming component whose largest electrical power demands during operation are intermittent;
principal power supply means for delivering sufficient electrical power to the load-consuming component for a major fraction of the period of operation of the load-consuming component yet is incapable for delivering sufficient electrical power to the load-consuming component during the remainder of the period of operation of the load-consuming component; and
an array of ultra-capacitors connected to the principal power supply means for supplying sufficient operating power to the load-consuming component during the fraction of the period of operation when the principal power supply cannot supply sufficient operating power to the load-consuming component.

6. The unit as defined in claim 5 wherein the array of ultra-capacitors is connected to the principal power supply so that during the period of operation of the load-consuming component when the load demands thereof are being met by the principal power supply, the ultra-capacitors of the array are capable of being recharged by the principal power supply.

7. The power supply assembly as defined in claim 5 wherein the array of ultra-capacitors is adapted to provide sufficient power to the load-consuming component over intermittent periods of time totaling no more than between about twenty-five to thirty-five percent of the operating time of the load-consuming component, and the principal power supply means is adapted to be able to provide the power demands of the load-consuming component for the remaining period of operating time of the load-consuming component.

8. The power supply assembly as defined in claim 7 wherein the load-consuming component with which the assembly is intended to be used is a one-hundred watt class solid state transceiver, and the plurality of ultra-capacitors has a total output capacity of about 13.5 volts DC.

9. In an electrical unit including a load-consuming component whose largest power requirements during operation are intermittent and wherein power is supplied to the load-consuming component from a principal power supply, the improvement characterized in that:
the principal power supply is sized to sufficiently meet the power requirements for the load-consuming component for a major fraction of the period of operation of the load-consuming component yet is insufficient to meet the load demands of the load-consuming component for the remainder of the period of operation of the load-consuming component; and
an array of ultra-capacitors connected in parallel with the principal power supply for supplying sufficient operating power to the load-consuming component during the fraction of the period of operation when the principal power supply cannot supply sufficient operating power to the load-consuming component and so that during the period of operation of the load-consuming component when the load demands thereof are being met by the principal power supply, the array of ultra-capacitors are capable of being recharged by the principal power supply.

10. The electrical unit as defined in claim 9 wherein the array of ultra-capacitors is adapted to provide sufficient power to the load-consuming component over intermittent periods of time totaling no more than between about twenty-five to thirty-five percent of the operating time of the load-consuming component, and the principal power supply means is adapted to be able to provide the power demands of the load-consuming component for the remaining period of operating time of the load-consuming component.

11. The electrical unit as defined in claim 10 wherein the load-consuming component with which the assembly is intended to be used is a one-hundred watt class solid state transceiver, and the plurality of ultra-capacitors has a total output capacity of about 13.5 volts DC.
